(19) United States
(12) Patent Application Publication
(10) Pub. No.: US 2003/0087607 A1
(43) Pub. Date: May 8, 2003

(54) Method for wireless modem carrier level control

(75) Inventors: Ronald W. Fraser, Lake Orion, MI (US); Dwayne Crocker, Oxford, MI (US)

Correspondence Address: ANTHONY LUKE SIMON, General Motors Corporation, 300 Renaissance Center, P.O. Box 300, Mail Code 482-C23-B21, Detroit, MI, 48265-3000, US

(73) Assignee: General Motors Corporation

(21) Appl. No.: 09/992,855

(22) Filed: Nov. 5, 2001

(51) Int. Cl. H04B 17/00

(52) U.S. Cl. 455/67.6; 455/67.1

(57) ABSTRACT

The invention provides a method for maintaining a consistent modem carrier level for a wireless communication system. A modem carrier is received at a communication node. The modem carrier signal strength is measured. A determination is made whether the modem carrier signal strength is at a prescribed level, and a modem carrier level instruction is sent from the communication node to adjust the modem carrier level based on the determination.

### FIELD OF THE INVENTION

This invention relates to a method for dynamically adjusting wireless modem carrier levels. More generally, the invention relates to a method and system for data communications over a wireless communication system.

### BACKGROUND OF THE INVENTION

Wireless modems send and receive data streams or data packets through an air interface. A radio frequency carrier is modulated in a prescribed fashion using one of a variety of modulation and encoding techniques, such as frequency modulation, frequency shift keying or phase shift modulation, to accurately transmit and receive data through the airwaves. Once a radio communication channel is established, an incoming signal from a wireless modem is received, amplified, demodulated and then reconstructed into data packets. An outgoing data packet is appropriately formatted, and an outgoing transmission is sent. Accurate and reliable transmission of data using a wireless modem requires careful control over modem carrier levels. Analog standards may not adequately govern data transmission across landline networks, making it difficult to set carrier levels in order to maintain proper data transmission. Excessively low carrier levels may not be detected by the receiver. Low carrier levels may be difficult to separate from noise in the system, resulting in data transfer errors or loss of signal. Carrier levels that are too high may cause excessive noise due to, for example, echo cancellation within the wireless and wire line networks. These conditions may also result in data transfer errors.

The demand for digital services is increasing rapidly with the proliferation of mobile or cellular phones. Digital services include, for example, short text messaging, voice messaging, paging, e-mailing, downloading, uploading and accessing the Internet. These phones are required to handle voice communications and data communications over the same RF channels. Similar communication services are needed for occupants or drivers of vehicles such as cars and trucks. A mobile phone used in a vehicle for voice and data communications places additional demands on the wireless transmission. Wireless communication devices and wireless communication services are desirable for use in a mobile vehicle, or in portable applications.

RF signal strengths may attenuate rapidly as a mobile phone user moves throughout a cell region. RF signal strengths may fade and become diminishingly weak at the edge of a cell region, and a communication link may be lost altogether. Other environmental effects may impact the data and voice transmission. The transmission may be affected by significant obstacles such as buildings or terrain, or by transitions through city streets, bridges and tunnels. Interference may be encountered from other mobile phones, corrupting data and making voice or data communications difficult. The transmissions may be affected by the speed at which a vehicle containing a wireless modem is approaching or moving away from a cellular base station. Temperature variations in the mobile vehicle may also affect the audio and RF signal strengths.

Wide variations in the audio signal level may exist due to the land-based portion of the communication network, as well as the wireless portion. Because wireless services focus on voice communications, significant digital signal processing is performed on transmissions through wireless and land-based systems to minimize cross talk, noise, crackling, fading and dropouts and to maintain quality voice communications over the cellular phone system and the land-based system. Consequently, data communications are inadvertently compromised in these systems. Modem carrier levels are affected by the signal level variations, which are caused predominantly by the wireless carrier, and to a lesser extent, by the land-based network and the phone hardware. Therefore, factory set carrier levels are inadequate in meeting the requirements of a wireless modem, particularly one carried on or mounted to a mobile vehicle. A dynamic method is needed to accommodate the significant changes in signal levels that occur between the wireless modem and a land-based modem during a communication session.

It would be desirable, therefore, to provide a method for dynamically adjusting modem carrier levels that would result in more reliable data communications and reduced exposure to network and vehicle variances.

### SUMMARY OF THE INVENTION

One aspect of the invention provides a method of maintaining consistent modem carrier level for a wireless communication system. A modem carrier may be received at a communication node. The signal strength of the modem carrier may be measured, and a determination made whether the modem carrier signal strength is at a prescribed level. A modem carrier level instruction may be sent from the communication node to adjust the modem carrier level based on the determination.

A modem carrier level instruction may contain a modem carrier level parameter. The modem carrier level parameter may be based on a reference modem carrier level at the communication node. The parameter may comprise one to eight bits of the modem carrier level instruction. The modem carrier level instruction may comprise a set of frequency tones. The modem carrier level may be adjusted in response to the modem carrier level instruction. Throughout a communication session, the modem carrier level may be adjusted one or more times.

The modem carrier signal strength may comprise making a single measurement at the beginning of a data communication segment. The modem carrier signal strength may be measured multiple times throughout a communication session. A communication session may comprise multiple data communication segments and one or more voice communication segments. The modem carrier may be received from an analog modem, or it may be received from a digital modem. The modem may be located in a mobile vehicle, or in a mobile communication device. Communication between the modem and the communication node may occur over an analog mobile telephone system, or over a digital mobile telephone system.

Another aspect of the current invention is a computer usable medium, including a program for maintaining a consistent modem carrier level for a wireless communication system.

The program may include computer program code for receiving the modem carrier at the communication node. The program may include computer program code for measuring the modem carrier signal strength, and code for determining if the modem carrier signal strength is at a prescribed level. The program may include code for sending a modem carrier level instruction from the communication node to the modem to adjust the modem carrier level based on the determination. The modem carrier level instruction may include a modem carrier level parameter. The program may include computer program code for adjusting the modem carrier level in response to the modem carrier level instruction. The modem carrier level may be adjusted one or more times throughout a communication session.

Another aspect of the current invention is a system for maintaining a consistent modem carrier level for a wireless communication system.

The wireless modem carrier level control system may comprise a means for receiving the modem carrier level at a communication node. The system may comprise a means for measuring the signal strength of the modem carrier, and determining whether the modem carrier signal strength is at a prescribed level. The system may comprise a means for sending a modem carrier level instruction from the communication node to adjust the modem carrier level based on the determination. The system may also include a means for adjusting the modem carrier level in response to the modem carrier level instruction.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment of a wireless modem carrier level control system for providing a consistent modem carrier level in accordance with the current invention;

FIG. 2 is a call flow diagram of one embodiment of a method for wireless modem carrier level control in accordance with the current invention;

FIG. 3 is a call flow diagram of another embodiment of a method for wireless modem carrier level control in accordance with the current invention; and

FIG. 4 is a schematic illustration of another embodiment of a method for wireless modem carrier level control in accordance with the current invention.

### DETAILED DESCRIPTION OF THE PRESENTLY PREFERRED EMBODIMENTS

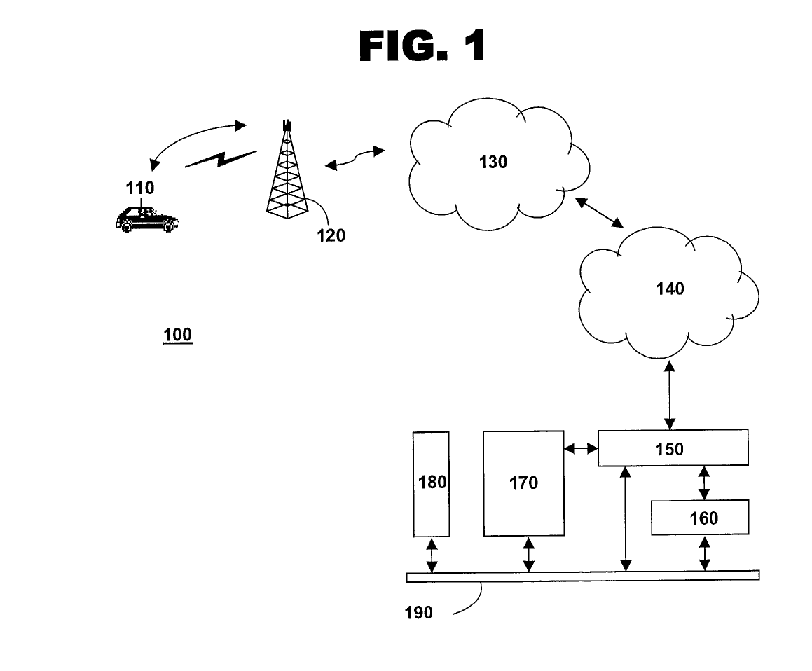

FIG. 1 shows one embodiment of a wireless modem carrier level control system for providing a consistent modem carrier level for a wireless communication system in accordance with the present invention at 100.

Wireless modem carrier level control system 100 may include one or more mobile communication devices 110; one or more carrier systems 120; one or more wireless networks 130; one or more land networks 140; and one or more communication nodes. A communication node may contain one or more data and voice switches 150; one or more communication node modems 160; one or more advisors 170; one or more vehicle communication services manager 180, and one or more bus systems 190. A communication node may be a call center. Alternatively, a communication node may be a modem card in a wireless modem bank, or a computer with a modem integrated circuit, or a digital signal processor with modem capability, or a stand-alone modem, or a portable wireless communication device, or another mobile communication device 110.

Mobile communication device 110 may be a portable wireless communication device, or a mobile vehicle equipped with suitable hardware and software for transmitting and receiving voice and data communications. Mobile communication device 110 may contain a wireless modem for transmitting and receiving data. The wireless modem may be an analog modem, or a digital modem. The wireless modem may reside in a digital signal processor located in the wireless communication device, or a host processor, or in a cellular phone, or in a mobile phone residing in a mobile vehicle. Mobile communication device 110 may be carried by a user or mounted in a mobile vehicle. Mobile communication device 110 may contain suitable hardware and software for transmitting and receiving voice and data communications. Mobile communication device 110 may send to and receive radio transmissions from carrier system 120.

Carrier system 120 may be a wireless communications carrier. Carrier system 120 may be, for example, a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications. Carrier system 120 may transmit to and receive signals from mobile communication device 110. Carrier system 120 may transmit to and receive signals from a second mobile communication device 110. Carrier system 120 may be connected with wireless network 130.

Wireless network 130 may comprise a mobile telephone switching office. Wireless network 130 may comprise another wireless communications company. Wireless network 130 may be any system connecting carrier system 120 to a second mobile communication device 110. Wireless network 130 may be any system connecting carrier system 120 to land network 140.

Land network 140 may be a public switched telephone network. Land network 140 may be comprised of a wired network, an optical network, a fiber network, another wireless network, or any combination thereof. Land network 140 may connect wireless network 130 with a second carrier system 120. Land network 140 may connect wireless network 130 to a communication node.

The communication node may contain a switch 150. Switch 150 may be connected to the land network 140, and may receive a modem carrier from an analog modem or from a digital modem. Switch 150 may transmit voice or data transmission from the communication node. Switch 150 may also receive voice or data transmissions from mobile vehicle 110 through carrier system 120, wireless network 130 and land network 140. Switch 150 may receive or send data transmissions to communication node modem 160, or receive or send voice transmissions to advisor 170.

Communication node modem 160 may send or receive data from switch 150. Modem 160 may transfer data to or from advisor 170, vehicle communication services manager 180, or any other device connected to bus system 190. Communication node modem 160 may be able to distinguish between an analog modem and a digital modem used in data transmissions from mobile vehicle 110, and operate accordingly.

Advisor 170 may be a real advisor or a virtual advisor. A real advisor may be a human being in verbal communication with mobile communication device 110. A virtual advisor may be a synthesized voice interface responding to requests from mobile communication device 110. Advisor 170 may provide services to mobile communication device 110. Services provided by advisor 170 may include navigation assistance, directory assistance, roadside assistance, business or residential assistance, information assistance, and emergency assistance. Advisor 170 may communicate with mobile communication device 110 using voice or data transmissions. Advisor 170 may communicate with vehicle communication services manager 180 or any other device connected to bus system 190.

Vehicle communication services manager 180 may be connected to switch 150, modem 160, and advisor 170 through bus system 190. Vehicle communication services manager 180 may determine whether voice or data transmissions are to occur with mobile communication device 110. Vehicle communication services manager 180 may provide instructions to switch 150 whether a communication segment is a voice segment or a data segment. Vehicle communication services manager 180 may provide instructions to modem 160 regarding timing, protocols and signal management. Signal management may include, for example, whether data to be sent or being received from mobile carrier 110 should be set to an analog protocol or a digital protocol. Signal management may also include measurement and analysis of incoming data streams from mobile communication device 110 to determine quality and level of the data, and to send instructions to mobile communication device 110 accordingly. Signal management may also include establishing connectivity and terminating calls. Vehicle communication services manager 180 may measure the modem carrier signal strength, and may determine whether the modem carrier signal strength is at a prescribed level. Vehicle communication services manager 180 may send a modem carrier level instruction from the communication node to adjust the modem carrier level based on the determination.

The communication node may contain a communication node modem 160. Communication node modem 160 may be a located in a second mobile communication device 110.

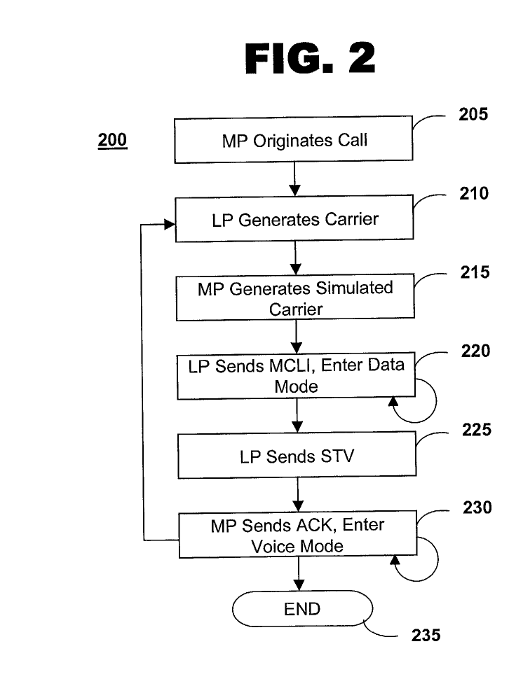

FIG. 2 shows a call flow diagram of one embodiment of a method for wireless modem carrier level control in accordance with the present invention at 200.

As seen at block 205, a mobile vehicle communications processor (MP) located at mobile communication device 110 originates a call. The call may be originated automatically, or in response to a request of an operator or occupant. A land-based processor (LP) located at a communication node generates a carrier in response to the call as seen at block 210. The land-based processor may be comprised of, for example, switch 150, communication node modem 160, advisor 170; and vehicle communication services manager 180. The carrier may be a fixed frequency or set of frequencies recognizable by the mobile processor. As seen at block 215, the mobile processor may generate a carrier. The mobile processor may contain a modem. A carrier may be, for example, a simulated carrier in the case of a digital modem. A carrier may also be, for example, a fixed frequency or set of frequencies in the case of an analog modem. For example, carrier frequencies may be 2070 Hz and 2270 Hz for binary data transmissions in one direction, and 1070 Hz and 1270 Hz for binary data transmission in the other direction. Carrier frequencies for a digital modem may vary over a portion of the audio frequency range, for example, from 300 Hz to 3400 Hz.

As seen at block 220, the land-based processor may send a carrier level control instruction to direct the mobile vehicle processor to adjust the carrier level of the modem. The modem carrier level instruction (MCLI) may instruct the modem carrier level to increase from its current level or decrease from its current level, depending whether the modem carrier level, as measured at the communication node, is at a prescribed level. The prescribed level may be an audio power of the carrier. The prescribed level may be a voltage amplitude of the modem carrier. The prescribed level may be a default value, or may be a value set by a user profile. The prescribed level may be nominally equal to the carrier level of the modem at the communication node. For example, the modem carrier level transmitted from the mobile vehicle may be approximately the same level as the modem at the communication node, as measured at a reference point. The reference point may be, for example, at the interface between land network 140 and communication node switch 150. The prescribed level may be equal to the carrier level of the communication node with an offset value based on quality measurements of the incoming data signals. The prescribed level may comprise a band of values around a target level.

The modem carrier level instruction may contain a modem carrier level parameter. The parameter may indicate the amount of incremental adjustment required, or the parameter may indicate an absolute level. When the mobile vehicle processor receives the instruction, the carrier level of the modem may be adjusted accordingly.

Data communications may take place, as indicated in block 220. Data communications may be sent from mobile communication device 110, or from communication node modem 160. Data communications may take place in a continuous mode, or in burst mode. A switch to voice (STV) mode may be requested by the land processor. A switch to voice instruction may be sent to mobile communication device 110 as seen at block 225. After acknowledgment by the mobile processor, voice mode may be entered as seen at block 230.

As seen at block 230, the land processor may remain in voice mode as long as desired, or may generate a carrier and re-enter data mode. When reentering the data mode, the mobile processor may send an actual or simulated carrier that may be received at the communication node. The modem carrier level may be measured at the communication node, and a determination made whether the modem carrier signal strength is at a prescribed level. The modem carrier level may be measured with a power level circuit. The modem carrier level may be measured with a peak detector and data converter circuitry. The modem carrier level may also be inferred from quality measurements of the data transmission. Based on the determination, the communication node may send a modem carrier level instruction from the communication node to adjust the modem carrier level as indicated at blocks 210, 215 and 220. The modem carrier signal strength may be measured at the beginning of each data communication segment, or it may be measured at multiple times during the data communication segment. The most recent measurement may be used when making the determination of the modem carrier level signal strength, or a weighted average of recent measurements may be used. The modem level may be adjusted in response to the modem carrier level instruction at the beginning of each data communication segment, or it may be adjusted more than once during the data communication segment if the communication segment is long.

The communication session may include one or more data communication segments, and may include none, one or multiple voice communication segments. When the communication session is completed, the session may end, as seen at block 235.

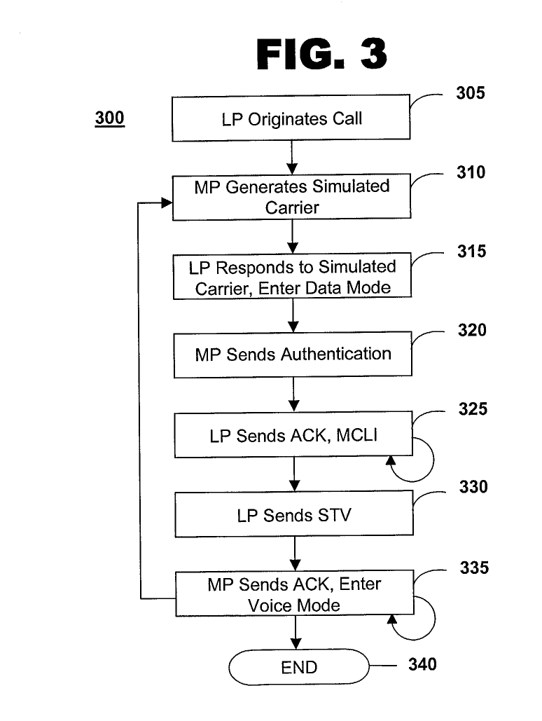

FIG. 3 shows a call flow diagram of another embodiment of a method for wireless modem carrier level control in accordance with the present invention at 300.

Call flow 300 shows a method for a call originated at the communication node. As seen at block 305, a land-based processor at a communication node may originate a call to mobile communication device 110. After the call is connected, the mobile vehicle communications processor located at mobile communication device 110 may generate a carrier as seen at block 310. The carrier may be an actual carrier in the case of an analog modem at mobile communication device 110, or a simulated carrier in the case of a digital modem at mobile communication device 110. The land processor may respond to the actual or simulated carrier and enter into data mode, as seen at block 315. As seen at 320, the mobile processor sends an authentication message. The land processor acknowledges the authentication message, and sends a mobile carrier level instruction as seen at block 325. The mobile carrier level instruction may direct the mobile vehicle processor to adjust the carrier level of the modem. The modem carrier level instruction may contain a modem carrier level parameter. The parameter may indicate the amount of adjustment requested. When the mobile vehicle processor receives the instruction, the carrier level of the modem may be adjusted accordingly. Data transfers may continue, as indicated at block 325. The modem carrier level may be monitored frequently during the data communication segment, and modem carrier level instructions may be sent once or many times during the segment.

When the data communications segment is completed, the call may enter into voice mode. As indicated at block 330, a switch to voice instruction is sent to mobile communication device 110 from the communication node. The mobile vehicle processor may acknowledge the instruction, and enter into voice mode as seen at block 335. Mobile communication device 110 and the communication node may be in voice mode as long as desired. Mobile communication device 110 may wish to re-enter data mode, and may generate an actual or simulated carrier as indicated at block 310. Modem carrier level instructions may be sent at any time during a data session, and modem carrier signal strength measurements may also be made at any time during a data session. The voice and data communication segments may end, as seen at block 340.

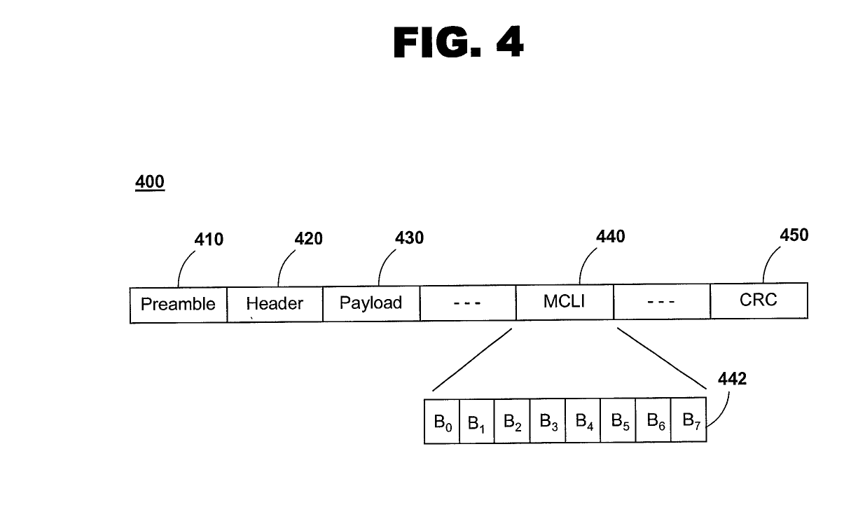

FIG. 4 shows a schematic illustration of a modem carrier level instruction for a method of wireless modem carrier level control in accordance with the present invention at 400.

Modem carrier level instruction 400 comprises a number of bytes in a data packet. Specific bytes in the data packet may correspond to specific functions. Initial bytes 410 may form a preamble, which may include timing and synchronization bytes. Header 420 may contain routing and identification information, along with information regarding the length of the payload 430 and other relevant information. A portion of the data packet contains a modem carrier level instruction 440. Modem carrier level instruction 440 may be one bit long, one byte long, or may be multiple bytes long. Modem carrier level instruction 440 may be comprised, for example, as a single bit in the header indicating the presence of a modem carrier level parameter. Modem carrier level parameter 442 may be constructed from eight bits. Alternatively, modem carrier level parameter 442 may be constructed from one or more bits. As an example, modem carrier level parameter 442 may comprise eight bits: the first two bits may be unspecified. The third bit may be a sign bit indicating an increment or a decrement to the modem carrier level. The last five bits may indicate, in binary format, a number related to the increment or decrement requested. For example, one bit may correspond to an increase or decrease of 0.5 dB of acoustic power, depending on the sign bit. One bit may correspond to an increment of 1.0 dB, or any other suitable increment. Information regarding the minimum increment or decrement size may be contained, for example, in the header or in the payload. Modem carrier level parameter 442 may be comprised of a single bit, wherein the single bit indicates whether the carrier level should be incremented or decremented by a pre-established increment. The modem carrier level parameter may be interpreted, for example, by the mobile vehicle processor, and the modem may be adjusted accordingly. The data packet may be terminated with a cyclical redundancy check code 450 that assists in error checking.

Alternatively, frequency tones may be used to control the modem carrier level in lieu of or in addition to a bit stream instruction. In the event that RF or other signal conditions prevent the successful transmission of a data message to control the audio power level of the wireless modem, communication node modem 160 may use a select or prescribed set of tones to instruct mobile communication device 110 to increase or decrease its modem carrier level or audio output power level. For example, four discrete tones may be used, two for instruction and two for response.

For example, a frequency F1 for 150 milliseconds may be used to instruct an increase of the modem carrier level by 0.5 dB. A frequency F2 for 150 milliseconds may be used to instruct a decrease of 0.5 dB. A frequency F3 for a duration of 50 milliseconds may be made in response to a modem carrier level increase, and a frequency F4 for a duration of 50 milliseconds may be made in response to a modem carrier level decrease. When mobile communication device 110 receives tone F1 for at least 150 milliseconds, it may increase its audio output level by 0.5 dB and respond to communication node 160 by transmitting tone F3 for at least 50 milliseconds. When mobile communication device 110 receives tone F2 for at least 150 milliseconds, it may decrease its audio output power level by 0.5 dB and respond to communication node 160 by transmitting tone F4 for at least 50 milliseconds.

In certain instances, mobile communication device 110 may adjust its modem carrier level or audio power level without an instruction from a communication node. Upon receiving an incoming modem signal, the received signal strength may be measured against a preset standard. The preset standard may be a voltage reference, or an audio power reference. If the incoming signal strength is higher than the preset standard, the system may be amplifying the data and the modem carrier level may be decreased. Conversely, if the incoming signal is attenuated from the preset standard, the modem carrier level may be increased. The received signal strength may be measured upon receiving an initial incoming modem signal, or may be measured each time a message is received. Controlling the modem carrier level with respect to a reference may be done in addition to sending instructions from one modem to another.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of maintaining consistent modem carrier level for a wireless communication system comprising:
receiving a modem carrier at a communication node;
measuring a modem carrier signal strength;
determining whether the modem carrier signal strength is at a prescribed level; and
sending a modem carrier level instruction from the communication node to adjust the modem carrier level based on the determination.

2. The method of claim 1 wherein the modem carrier level instruction comprises a modem carrier level parameter.

3. The method of claim 2 wherein the modem carrier level parameter comprises a range between one and eight bits of the modem carrier level instruction.

4. The method of claim 1 wherein the modem carrier level instruction comprises select frequency tones.

5. The method of claim 1 further comprising:
adjusting the modem carrier level in response to the modem carrier level instruction.

6. The method of claim 5 wherein the modem carrier level is adjusted more than one time during a communication session.

7. The method of claim 1 wherein measuring the modem carrier signal strength comprises making a single measurement at a beginning of a data communication segment.

8. The method of claim 1 wherein measuring the modem carrier signal strength comprises making a plurality of measurements throughout a communication session.

9. The method of claim 8 wherein the communication session comprises one or more data communication segments and one or more voice communication segments.

10. The method of claim 1 wherein the modem carrier is received from an analog modem.

11. The method of claim 1 wherein the modem carrier is received from a digital modem.

12. The method of claim 1 wherein the modem carrier is received from a modem located in a mobile communication device.

13. The method of claim 1 wherein the wireless communication system is an analog mobile telephone system.

14. The method of claim 1 wherein the wireless communication system is a digital mobile telephone system.

15. The method of claim 1 wherein the prescribed level is based on a reference modem carrier level at the communication node.

16. A computer usable medium including a program for maintaining a consistent modem carrier level for a wireless communication system, comprising:
computer program code for receiving a modem carrier at a communication node;
computer program code for measuring a modem carrier signal strength;
computer program code for determining whether the modem carrier signal strength is at a prescribed level; and
computer program code for sending a modem carrier level instruction from the communication node to a modem to adjust the modem carrier level based on the determination.

17. The computer usable medium of claim 16 wherein the modem carrier level instruction comprises a modem carrier level parameter.

18. The computer usable medium of claim 16 further comprising:
computer program code for adjusting the modem carrier level in response to the modem carrier level instruction.

19. The computer usable medium of claim 18 wherein the modem carrier level is adjusted one or more times during a communication session.

20. A wireless modem carrier level control system comprising:
means for receiving a modem carrier at a communication node;
means for measuring a modem carrier signal strength;
means for determining whether a modem carrier signal strength is at a prescribed level; and
means for sending a modem carrier level instruction from the communication node to adjust the modem carrier level based on the determination.

21. The system of claim 20 further comprising:
means for adjusting the modem carrier level in response to the modem carrier level instruction.
